(19) United States
(12) Patent Application Publication
(10) Pub. No.: US 2018/0188400 A1
(43) Pub. Date: Jul. 5, 2018

(54) SYSTEM FOR MARINE SEISMIC REFRACTION SURVEY USING REMOTELY PILOTED AIR/WATER DRONE AND METHOD THEREOF

(71) Applicant: Korea Institute of Geoscience and Mineral Resources, Daejeon (KR)

(72) Inventors: Young-Jun KIM, Daejeon (KR); Nam-Hyung Koo, Daejeon (KR); Ho-Young Lee, Daejeon (KR); Soon Hong Cheong, Sejong-si (KR); Jong Hwa Chun, Daejeon (KR); Jung Ki Kim, Daejeon (KR); Kyu Duk Hwang, Sejong-si (KR); SungDoo Hong, Goyang-si (KR); Sin Heo, Goyang-si (KR); GiDon Moon, Incheon (KR); CheolHun Jeong, Busan (KR)

(73) Assignee: Korea Institute of Geoscience and Mineral Resources, Daejeon (KR)

(21) Appl. No.: 15/822,872

(22) Filed: Nov. 27, 2017

(30) Foreign Application Priority Data
Dec. 29, 2016 (KR) 10-2016-0182531

(51) Int. Cl. G01V 1/38; G01V 1/20; G01V 1/00; G01V 1/18; G05D 1/04; G05D 1/02

(52) U.S. Cl. CPC G01V 1/3817; G01V 1/201; G01V 1/003; G01V 1/3808; B63B 2035/008; G05D 1/048; G05D 1/0206; G05D 1/0202; G01V 1/186

(57) ABSTRACT

The present invention relates to a system for marine seismic refraction survey using a remotely piloted air/water drone and a method thereof for acquiring refracted wave by providing a receiver on the air/water drone among marine seismic methods, being configured to include: a surveyvessel provided with a seismicsource generating a sound; and the air/water drone moving tethered to the surveyvessel while floating on the sea or operating under water and being capable of moving to a desired location by generating a lift force and a turning force through remote control. In addition, the system is to be used for marine seismic refraction survey by providing a hydrophone and streamer and a recording system which may record the seismic wave on an air/water drone, a remotely piloted marine observation system, whereby an effect is given to be able to acquire data of seismic refraction.

### BACKGROUND OF THE INVENTION

### Field of the Invention

The present invention relates to a system for a marine seismic refraction survey using a remotely piloted air/water drone and a method thereof. More particularly, the present invention relates to a system for a marine seismic refraction survey using, among marine seismic survey methods, a remotely piloted air/water drone and a method thereof for acquiring a refracted wave by providing a geophone on the air/water drone.

### Description of the Related Art

A seismic survey is a geophysical exploration method identifying sub-surface media information by recording an artificially generated seismic wave from a seismicsource such as dynamite, a vibrator, etc. on the land, an air gun, and a sparker, a boomer, etc. on the sea, through a geophone on the land or a hydrophone, a streamer, etc. on the sea.

FIG. 1 is a drawing illustrating a typical method for seismic reflection survey and FIG. 2 is a drawing illustrating to explain a typical method for seismic refraction survey.

Referring to FIGS. 1 and 2, seismic survey may be largely divided in seismic reflection survey as in FIG. 1 and seismic refraction survey as in FIG. 2. The seismic reflection survey s in FIG. 1 makes an image of interfaces between strata by recording a signal returning back by reflection of the seismic wave. The seismic refraction survey as in FIG. 2 may derive seismic ray path penetrating a ground layer with wave velocity of bedrock by using a signal returning back by refraction of the seismic wave.

On the land, seismic refraction survey may be easily conducted because the geophone is installed at the ground directly, whereas, in marine seismic refraction survey, specific data acquisition systems are required due to a constraint condition of non-stationary seawater.

Marine seismic refraction survey is carried out for engineering purposes such as constructing a structure on the sea such as a bridge, an undersea tunnel, etc., monitoring of comparison of before and after production of petroleum/gas and carbon capture and storage (CCS), and geotectonic research such as researching basin characteristics, and a seismic receiver, an acquisition system, a survey scale, etc. to be used vary accordingly.

FIG. 3 is a drawing illustrating a refraction survey method using a sonobuoy typically used for engineering purposes, and FIG. 4 is a drawing illustrating a survey method using an ocean bottom cable (OBC) typically used for engineering purposes as streamers.

As in FIG. 3, refraction survey is performed by using a sonobuoy on the sea for engineering purposes. To explain in more detail, in survey using a sonobuoy, when a surveyvessel provided with the sound source (a vessel for the seismicsource) passes through the spot of a predetermined location in a straight line after launching the sonobuoy at a predetermined location, a refracted wave is recorded by the sonobuoy. However, in order to survey another location, withdrawal of the sonobuoy has to be accomplished and identification of the precise location of the sonobuoy is difficult due to a sea current and a tidal current.

As in FIG. 4, a small scale OBC is used as a streamer set. The survey method using a small scale OBC, as in FIG. 4, requires the vessel for the seismicsource and a separate signal recording surveyvessel recording the refracted wave. In addition, depending on the depth of water, a length of cable connected from the vessel to the sea-bed varies, in particular, the cable length may become insufficient as the water becomes deeper.

FIG. 5 is a drawing illustrating another method of surveying by using OBC typically used f or engineering purposes as a streamer set, FIG. 6 is a drawing illustrating an example of monitoring by using equipment wherein a typical recording device of the sea-bed is composed of ocean bottom node (OBN) type, and FIG. 7 is a drawing illustrating an example of monitoring by using a typical sea-bed seismometer.

In a survey system illustrated in FIG. 5, another embodiment of monitoring by using an OBC as a streamer set is illustrated. A survey system illustrated in FIG. 6 is the system that is used for monitoring a petroleum/gas reservoir being producted, a, and carbon capture & storage, and even produces, by using a S-wave, an image of information which may not be identified in a seismicsection of a P-wave, wherein the seismicsection of the P-wave is typically produced by using not only a sea-bed refraction survey but also a multi-component geophone. However, many millions of dollars are necessary to construct such a system. Furthermore, a special geophysical survey vessel should be operated to use the system. Consequently, such a surveying system is not appropriate for engineering purposes.

Referring to FIG. 7, a surveying system illustrated in FIG. 7 uses an ocean bottom seismometer (OBS) system, wherein, after positioning several numbers of CBS's at equidistant intervals on the sea-bed, the surveyvessel surveys by blasting an air-gun over the CBS's. Then, after letting the CBS's float to the water surface, survey data are backed up. Since the purpose of the OBS survey is geotectonic research, from points of view that a target depth for the survey reaches several kilometers and a cost is excessively high, such a survey system is inappropriate for engineering purpose. There are possibilities of missing OBS while the installation and recovery process.

### Documents of Related Art

### [Patent Document 0001]

(Patent Document 1) Korean Patent Application Publication No. 10-2012-0076952 (Title of the invention: Development of OBC type streamer device for marine seismic refraction method in the marine).

### SUMMARY OF THE INVENTION

### Technical Problem

Accordingly, the present invention has been made keeping in mind the above problems occurring in the related art, and the object of the present invention is intended to be used for marine seismic refraction survey by providing a geophone and a recording system which can record a refracted seismic wave by an air/water drone of a remotely piloted marine observation system, whereby the present invention provides a system for a marine seismic refraction surveying using a remotely piloted air/water drone and a method thereof which can ac quire seismic refraction data.

### Technical Solution

In order to accomplish the above object, according to one aspect, the present invention provides a system for a marine seismic refraction survey using a remotely piloted air/water drone, the system including: a surveyvessel provided with a seismicsource generating a seismic wave; and an air/water drone moving tethered to the surveyvessel while floating on the sea or operating under water and being capable of moving to a desired location by generating a lift force and a turning force through remote control and recording a seismic wave, the air/water drone being provided with a geophone receiving a seismic wave which is a seismic wavegenerated from the seismicsource provided on the surveyvessel and refracted by a sea-bed.

The surveyvessel may include: the seismicsource generating the seismic wave; a triggering generation unit operating synchronized by global positioning system (GPS) time or an atomic clock to synchronize the trigger ti me of seismicsource with the recording time at the air/water drone and indicating a blasting time and a terminating time of the seismicsource; and a surveyvessel communication unit transmitting a command signal to the air/water drone and receiving the seismic wave recorded on the air/water drone in response to the command signal.

The air/water drone may include: an air/water drone communication unit receiving the command signal output from the surveyvessel and transmitting the recorded seismic wave;

a receiver receiving a seismic wave which is a sound generated from the seismicsource provided on the surveyvessel and refracted by a sea-bed or by shallow sub-surface medium of sea-bed;

a recording unit recording the received seismic wave; and

a driving unit being started up by a floating force control of an underwater operating body and generating the lift force and the turning force.

The receiver may be implemented by using any one of a hydrophone and a streamer set.

The surveyvessel and the air/water drone may communicate by radio with each other by using any one selected from communication using a global positioning system (GPS), a satellite, Wi-Fi, and ultra-high frequency (UHF).

In order to accomplish the above object, according to another aspect, the present invention provides a method for marine seismic refraction survey using a system including a surveyvessel and a remotely piloted air/water drone, the surveyvessel being provided with a seismicsource generating a seismic wave; and the air/water drone moving tethered to the survey vessel while floating on the sea or operating under water and being capable of moving to a desired location by the lift force and the turning force generated through remote control and recording a seismic wave, the air/water drone being provided with a receiver receiving a seismic wave which is a seismic wavegenerated from the seismicsource provided on the surveyvessel and refracted by a sea-bed, the method including:

after positioning the air/water drone at a predetermined location, performing a first process of blasting the seismicsource of the seismic wave along a track linepassing over the predetermined location and receiving a refracted seismic wave;

after positioning the air/water drone at a first other location spaced apart as much as a distance 1 from the predetermined location, performing a second process of blasting the seismicsource of the seismic wave along a track passing over the first other location and receiving a refracted seismic wave; and

after positioning the air/water drone at a second other location spaced apart as much as a distance 1 from the predetermined location in a direction opposite to the first other location, performing a third process of blasting the seismicsource of the seismic wave along a track passing over the second other location and receiving a refracted seismic wave.

The method may further include: recording seismic wave information surveyed through the first to third processes; and

transmitting the recorded seismic wave information in response to a command signal output from the surveyvessel in order to control a survey quality and backup the data.

The and the air/water drone may communicate by radio with each other by using any one selected from communication using the GPS, a satellite, Wi-Fi, and ultra high frequency (UHF).

### Advantageous Effects

Accordingly, the system for marine seismic refraction survey using the remotely piloted air/water drone and the method thereof of the present invention is to be used for marine seismic refraction survey by providing a hydrophone or a streamer and a recording system which can record data from this device on an air/water drone of a remotely piloted marine observation system, whereby seismic refraction data are acquired.

In addition, the system for marine seismic refraction survey using the remotely piloted air/water drone and the method thereof of the present invention differs from a sonobuoy system in that a sonobuoy does not need to be withdrawn to for seismic survey other locations and to precisely estimate a location due to a sea current and a tidal current, since the air/water drone has a function that is able not only to be positioned at a predetermined location but also to move to another location autonomously, which makes surveying more efficient and.

In addition, since the air/water drone may move autonomously, the system for marine seismic refraction survey using the remotely piloted air/water drone and the method thereof of the present invention has an effect of being able to carry out marine refraction survey at an area where the movement of the surveyvessel is restricted, for example, the area of shallow water depth and in polar regions having glaciers, etc.

### BRIEF DESCRIPTION OF DRAWINGS

FIG. 1 is a drawing illustrating a typical method for seismic reflection survey

FIG. 2 is a drawing illustrating a typical method for seismic refraction survey.

FIG. 3 is a drawing illustrating a method of a refraction survey using a sonobuoy typically used for engineering purposes

FIG. 4 is a drawing illustrating a survey method using an ocean bottom cable (OBC) as a streamer set typically used for engineering purposes.

FIG. 5 is a drawing illustrating another method of survey by using OBC as a streamer typically used for engineering purposes.

FIG. 6 is a drawing illustrating an example of monitoring by using equipment wherein a typical recording device of the sea-bed is composed of ocean bottom node (OBN) type.

FIG. 7 is a drawing illustrating an example of monitoring by using a typical sea-bed seismometer.

FIG. 8 is a block diagram illustrating an organization of a system surveying by using marine seismic refraction using a remotely piloted air/water drone according to an embodiment of the present invention.

FIG. 9 is a block diagram illustrating the organization of a surveyvessel in FIG. 8 according to the embodiment of the present invention.

FIG. 10 is a block diagram illustrating the organization of the air/water drone in FIG. 8 according to the embodiment of the present invention.

FIG. 11 is a flow chart illustrating a marine seismic refraction survey method using a remotely piloted air/water drone according to an embodiment of the present invention.

FIG. 12 is a conceptual diagram illustrating a location of the air/water drone and a concept of a track along which the air/water drone proceeds according to the method of the present invention of FIG. 11.

FIG. 13 is a drawing illustrating a set of seismicdata acquired by the marine seismic refraction using the remotely piloted air/water drone according to the embodiment of the present invention.

FIG. 14 is a drawing illustrating a P-wave velocity estimated through a travel path and a process for a first arrival picking method for a received refracted wave according to the embodiment of the present invention.

FIG. 15 is a drawing illustrating a speed cross-sect ion of ground layers by performing refraction tomographic analysis using data from the first arrival picking method according to the embodiment of the present invention.

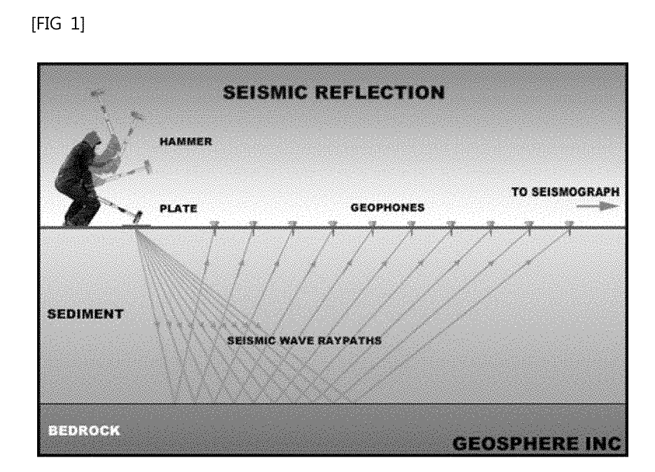

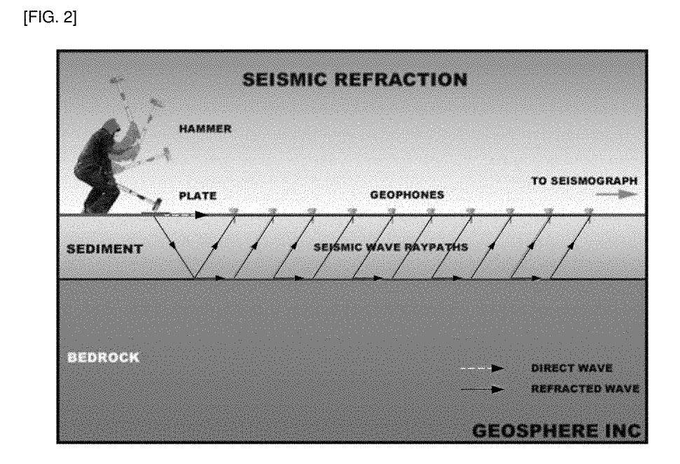

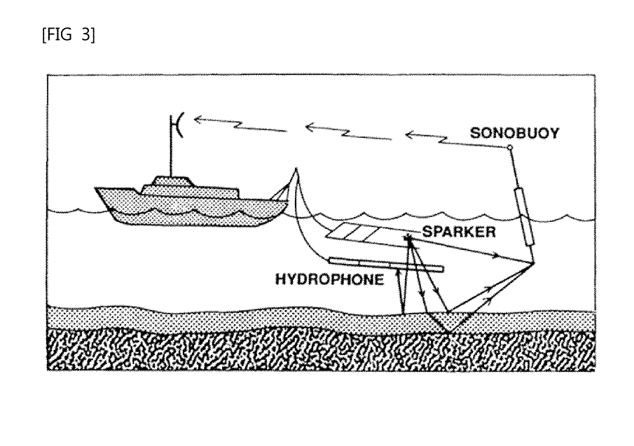

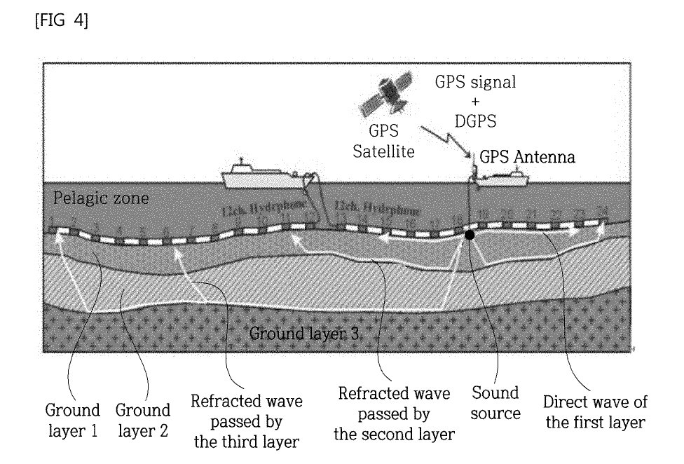

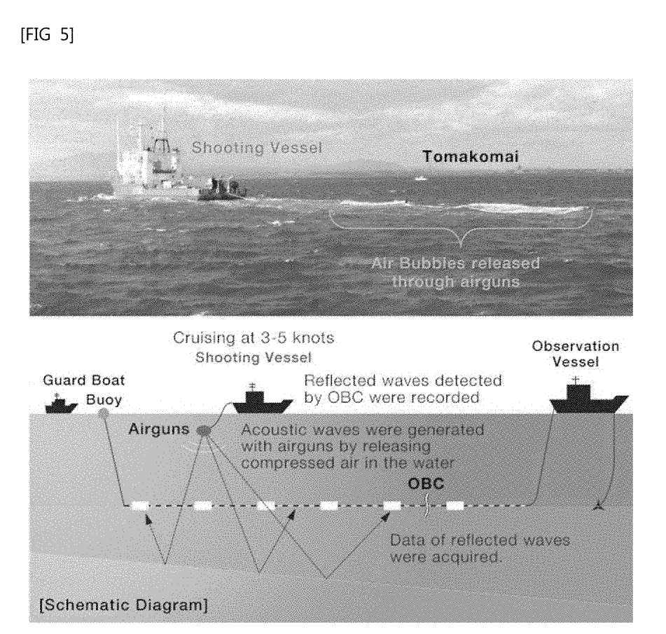

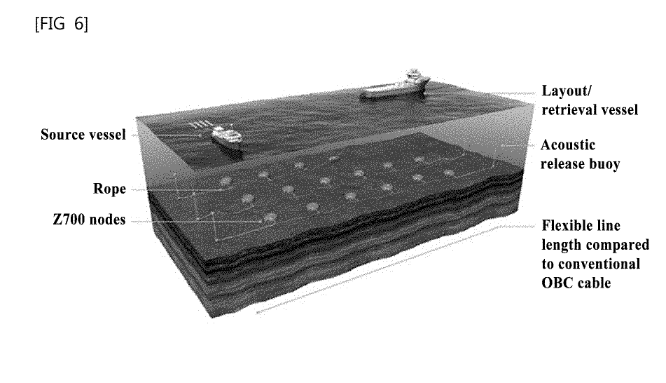

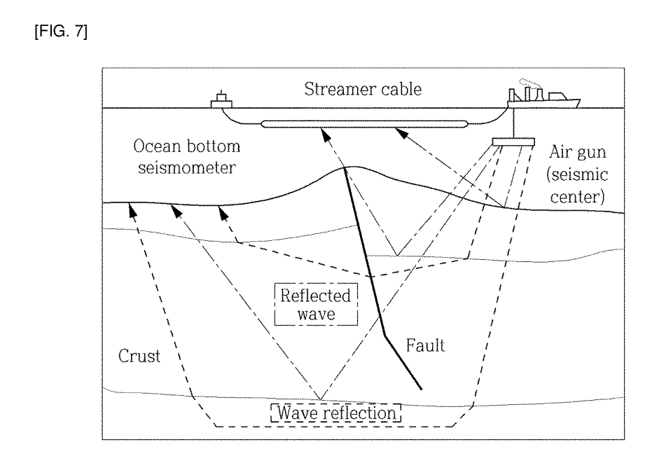

### DETAILED DESCRIPTION OF THE INVENTION

Hereinafter, exemplary embodiments of the present invention will be described in detail with reference to the accompanying drawings. Throughout the drawings, the same reference numerals will refer to the same or like parts.

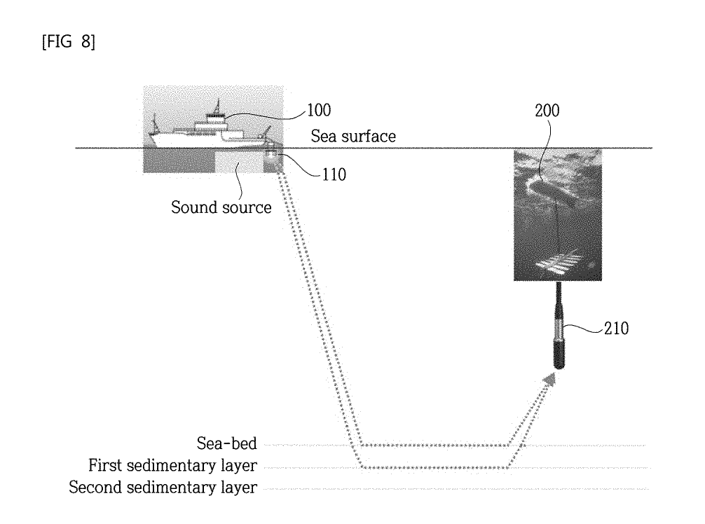

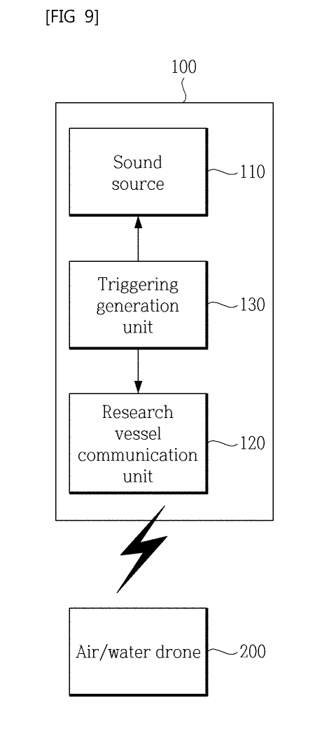

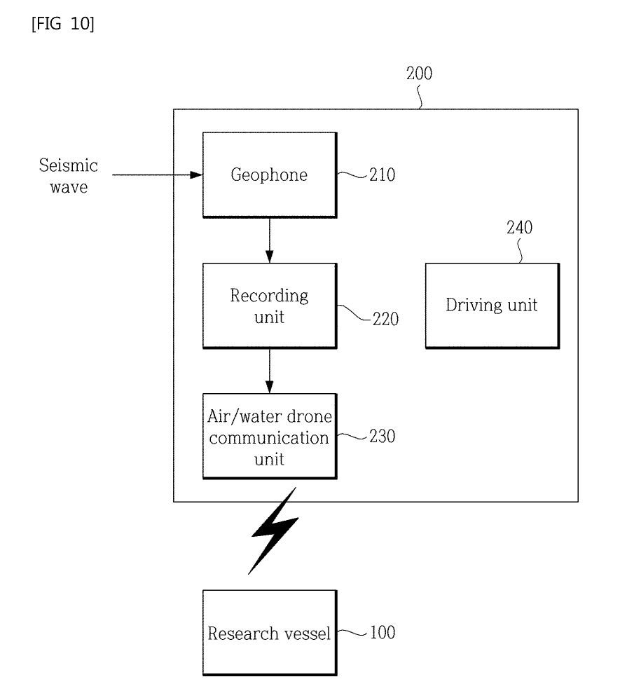

FIG. 8 is a block diagram illustrating a schematic diagram of marine seismic refraction survey method using the remotely piloted air/water drone according to an embodiment of the present invention, FIG. 9 is a block diagram illustrating the organization of the surveyvessel in FIG. 8 according to an embodiment of the present invention, and FIG. 10 is a block diagram illustrating the organization of the air/water drone in FIG. 8 according to an embodiment of the present invention.

Referring to FIGS. 8 to 10, the system of the present invention is largely composed of the surveyvessel 100 and the air/water drone 200.

The surveyvessel 100 is configured by including a sound source 110, a surveyvessel communication unit 120, and a triggering generation unit 130.

The seismicsource 110 generates a seismic wave. Meanwhile, the seismicsource 110 provided on the surveyvessel 100 actuates by being triggered by the triggering generation unit 130. Therefore, the surveyvessel 100 actuates not only synchronized by the triggering generation unit 130 but also synchronized with the air/water drone 200 by transmitting a system setting time thereto.

The recording unit 220 of the air/water drone 200 actuates by synchronizing time with the GPS time or an atomic clock, etc. of the surveyvessel 100, because recording should be performed for a period as long as a preset record length. That is, the triggering generation unit 130 may be the GPS time or an atomic clock, and actuates synchronized with the seismicsource 110 by using the GPS time or an atomic clock. For example, the air/water drone 200 is allowed to be able to recognize the time of initiation and termination of recording for a seismic wave, by indicating time of blasting and terminating of the sound by the triggering generation unit 130.

The air/water drone 200 floats on the sea or operates under water. The air/water drone 200 may move tethered to the seismic vessel and is preferably configured to be able to move to a desired location by generating the lift force and the turning force through remote control. The air/water drone 200 starts up by floating force control of an underwater operating body and may move by generating the lift force and the turning force by the driving unit 240.

The air/water drone 200 is composed of a receiver 210, an air/water drone communication unit 230, and a driving unit 240.

The receiver 210 receives a seismic wave generated from the seismicsource 110 provided on the surveyvessel 100 and refracted by a sea-bed. The geophone 210 may be implemented by using any one of a hydrophone and a streamer set.

A recording unit 220 of the air/water drone 200 records a received seismic wave generated from the seismicsource 110 provided on the surveyvessel 100 and refracted by a sea-bed. An air/water drone communication unit 230 transmits seismic wave information of survey data to the surveyvessel 100 once it receives a command signal output from the surveyvessel 100 in order for the surveyvessel to be able to monitor in real time to confirm that recording of the seismic wave is smoothly performed at the recording unit 220.

Meanwhile, a surveyvessel communication unit 120 of the surveyvessel 100 and an air/water drone communication unit 230 of the air/water drone 200 transmit and receive by radio communication the command signal and the recorded seismic wave, wherein any one means selected from communication using GPS, a satellite, Wi-Fi, and ultra-high frequency (UHF) may be used for radio communication.

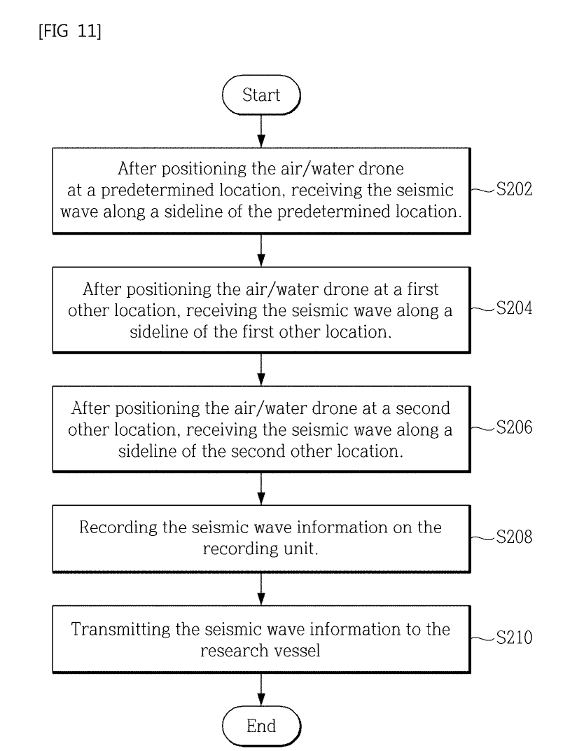

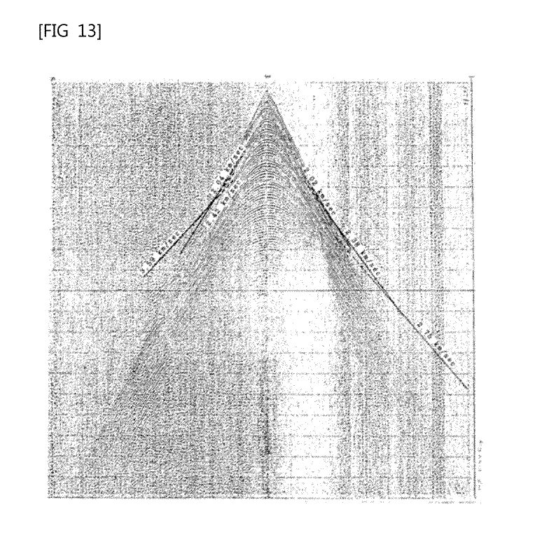

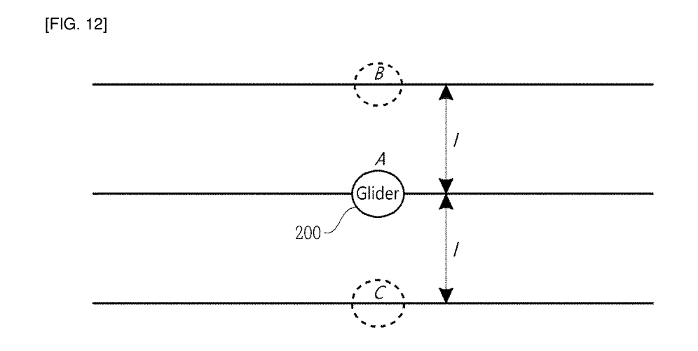

FIG. 11 is a flow chart illustrating the marine seismic refraction survey method using the remotely piloted air/water drone according to an embodiment of the present invention, and FIG. 12 is a conceptual diagram illustrating a location of the air/water drone and a concept of the track along which the air/w ater drone proceeds according to FIG. 11 of the present invention.

Referring to FIGS. 11 and 12, at step S202, after positioning the air/water drone 200 at a predetermined location (spot A), the sound is blasted through the seismicsource 110 of the seismic wave along the track passing over the spot A and the refracted seismic wave is received.

At step S204, after positioning the air/water drone 200 at a first other location spaced apart as much as a distance 1 from the predetermined location, the seismic is blasted along the track line passing the first other location (spot B) and the refracted seismic wave is received.

At step S206, after positioning the air/water drone 200 at a second other location (spot C) spaced apart as much as a distance 1 from the predetermined location in a direction opposite to the opposite direction of the first other location, the seismic source is blasted along the track passing the first other location (spot B) and the refracted seismic wave is received.

Referring to FIG. 12, a process for seismic source 110 generated a seismic wavealong the track s and receiving a refracted seismic wave is illustrated. That is, at step S202, the air/water drone 200 is positioned at the track of the spot A and survey is performed on the track.

At step S204, the air/water drone 200 is positioned at the spot B the spaced apart as much as a distance 1 from the spot A and survey is performed.

At step S206, a process is illustrated such that the air/water drone 200 is positioned at the spot C spaced apart as much as a distance 1 from the spot A to the opposite direction of the spot B and survey is performed.

Referring to FIG. 11 again, the seismic wave information surveyed from step S202 to step S206 is recorded on the recording unit 230 of the air/water drone at step S208.

The seismic wave recorded in recording step at step S210 is transmitted to the surveyvessel 100 in response to the command signal output from the surveyvessel 100.

The communication by which the surveyvessel 100 and the air/water drone 200 transmit and receive the command signal and the seismic wave information may be implemented by using any one selected from communication using the GPS, a satellite, Wi-Fi, and ultra high frequency (UHF).

Meanwhile, the air/water drone 200 which is one long-term marine observation system moves by controlling floating force without a propulsion system and, therefore, needs a small amount of power whereby various marine observation data such as water temperature, salinity, etc. may be collected in the long term. The air/water drone 200 may be positioned at a predetermined location and has a function to move to a desired location by the driving unit 230. Therefore, after providing a hydrophone or streamer as a receiver 210 which may receive a seismic wave signal in the air/water drone 200, once a seismic recording instrument which may record the seismic wave is provided, seismic refraction survey which may replace sonobuoy may be performed.

As in FIG. 12, after positioning the air/water drone 200 at the spot A, survey is performed by blasting the seismicsource of the seismic wave along the track passing over the spot A. Next, after positioning the air/water drone 200 at the spot B spaced apart as much as a distance 1, survey is also to be performed along the track line passing over the spot B. Finally, after positioning the air/water drone 200 at the spot C, survey is performed the same way, and then the seismic refraction survey with respect to the three track is completed.

Since the air/water drone 200 has a function to be positioned at a predetermined location and a function to move to a desired location autonomously by the driving unit 230, the air/water drone 200 differs from a sonobuoy system in that a sonobuoy does not need to be withdrawn to for survey other locations and to estimate precise location due to a sea current and a tidal current.

In addition, since the air/water drone 200 may move autonomously, marine refraction survey may be performed at an area where the movement of the surveyvessel is restricted, for example, the area in shallow water depth and polar region with glaciers, etc.

Since the recording unit 220 of the air/water drone 200 should record for a period of as much as record length being set once the seismic wave is blasted from the seismicsource, it should have a function to synchronize time with the GPS time or an atomic clock, etc. Thus, the received seismic wave should be recorded once the seismicsource is blasted. In addition, the recording system should have a function to transmit the survey data by radio communication for the surveyvessel to be able to monitor in real time to confirm that recording of the seismic wave is smoothly performed at the recording instrument of the air/water drone.

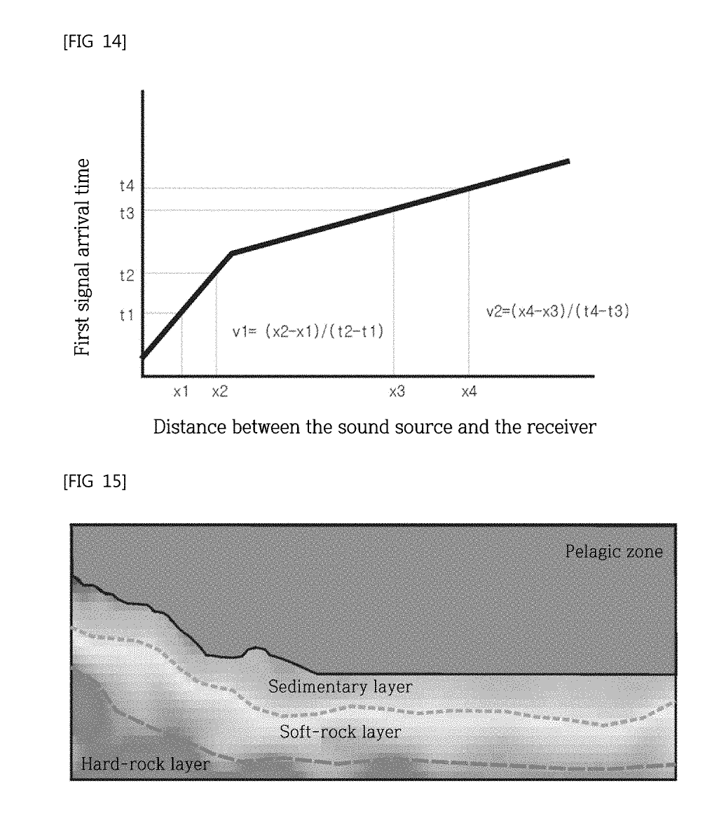

FIG. 13 is a drawing illustrating a set of survey data acquired by the marine seismic refraction using the remotely piloted air/water drone according to an embodiment of the present invention, FIG. 14 is a drawing illustrating a ground layers wave velocity of bedrock estimated through the travel path and the process for a first arrival picking method for the received refracted wave according to an embodiment of the present invention, and FIG. 15 is a drawing illustrating a velocity section of the ground layers by performing refraction tomographic analysis using data from the first arrival picking method according to an embodiment of the present invention.

Referring to FIGS. 13 to 15, FIG. 13 is a set of data acquired by the marine seismic refraction, FIG. 14 illustrates the ground layer wave velocity estimated through the travel path and the process for a first arrival picking method (see FIG. 11) for the refracted wave by using the survey data of FIG. 13. Ref erring to FIG. 15, the wave velocity section of the desired ground layers may be finally derived by performing refraction tomographic analysis using data from the first arrival picking method of FIG. 14, whereby engineering physical properties of the ground layers are estimated.

Although a preferred embodiment of the present invention as illustrated in the accompanying drawings has been described for illustrative purposes, those skilled in the art will appreciate that various modifications and another comparable embodiments are possible. Accordingly, the scope of the true technical protection should be defined based on the technical spirit of the invention as disclosed in the accompanying claims.

### DESCRIPTION OF THE REFERENCE NUMERALS IN THE DRAWINGS

100: Surveyvessel
110: Seismicsource
120: Surveyvessel communication unit
130: Triggering generation unit
200: Air/water drone
210: Receiver
220: Recording unit
230: Air/water drone communication unit
240: Driving unit

1. A system for marine seismic refraction survey using a remotely piloted air/water drone, the system comprising:
a survey vessel provided with a seismic source generating a seismic wave; and
an air/water drone moving tethered to the survey vessel while floating on the sea or operating under water and being capable of moving to a desired location by generating a lift force and a turning force through remote control and recording a seismic wave, the air/water drone being provided with a receiver receiving the seismic wave which is a seismic wave generated from the seismic source provided on the surveyvessel and refracted by a seabed,
wherein the survey vessel includes:
the seismic source generating the sound;
a triggering generation unit operating synchronized by global positioning system (GPS) time or an atomic clock to synchronize the sound source and the air/water drone and indicating a blasting time and a terminating time of the seismicsource; and
a survey vessel communication unit transmitting a command signal to the air/water dr one and receiving the seismic wave recorded on the air/water drone in response to the command signal, and
the air/water drone includes:
an air/water drone communication unit receiving the command signal output from the survey vessel and transmitting the recorded seismic wave;
a receiver receiving the seismic wave which is a seismic wavegenerated from the seismicsource provided on the survey vessel and refracted by a sea-bed;
a recording unit recording the received seismic wave; and
a driving unit being started up by a floating force control of an underwater operating body and generating the lift force and the turning force.

2. (canceled)

3. (canceled)

4. The system of claim 1, wherein the receiver is implemented by using anyone of a hydrophone and a streamer set.

5. The system of claim 1, wherein the survey vessel and the air/water drone communicate by radio with each other by using any one selected from communication using a global positioning system (GPS), a satellite, Wi-Fi, and ultra high frequency (UHF).

6. A method for a marine seismic refraction survey using a system including a survey vessel and a remotely piloted air/water drone, the surveyvessel being provided with a seismic source generating a seismic wave; and the air/water drone moving tethered to the survey vessel while floating on the sea or operating under water and being capable of moving to a desired location by a lift force and a turning force generated through remote control and recording a seismic wave, the air/water drone being provided with a receiver receiving a seismic wave which is a sound generated from the seismic source provided on the research vessel and refracted by a sea-bed, the method comprising:
after positioning the air/water drone at a predetermined location, performing a first process of blasting the seismic source of the seismic wave along a track passing over the predetermined location and receiving a refracted seismic wave;
after positioning the air/water drone at a first other location spaced apart as much as a distance 1 from the predetermined location, performing a second process of blasting the seismic source of the seismic wave along a track line passing over the first other location and receiving a refracted seismic wave; and
after positioning the air/water drone at a second other location spaced apart as much as a distance 1 from the predetermined location in a direction opposite to the first other location, performing a third process of blasting the seismic source of the seismic wave along a track passing over the second other location and receiving a refracted seismic wave.

7. The method of claim 6, further comprising:
recording seismic wave information surveyed through the first to third processes; and
transmitting the recorded seismic wave information in response to a command signal out put from the survey vessel.

8. The method of claim 6, wherein the survey vessel and the air/water drone communicate by radio with each other by using any one selected from communication using a global positioning system (GPS), a satellite, Wi-Fi, and ultra high frequency (UHF).
